(19) United States
(12) Patent Application Publication
(10) Pub. No.: US 2019/0308727 A1
(43) Pub. Date: Oct. 10, 2019

(54) Galley Monument For An Aircraft And Aircraft

(71) Applicant: Airbus Operations GmbH, Hamburg (DE)

(72) Inventors: Christian Riedel, Hamburg (DE); Falk Bajorat, Hamburg (DE); Olaf Schlatter, Hamburg (DE); Michael Bauer, Hamburg (DE)

(73) Assignee: Airbus Operations GmbH, Hamburg (DE)

(21) Appl. No.: 16/373,855

(22) Filed: Apr. 3, 2019

(30) Foreign Application Priority Data
Apr. 9, 2018 (DE) 10 2018 205 268.9

(51) Int. Cl. B64D 11/00; B64D 11/04

(52) U.S. Cl. CPC B64D 11/0015; B64D 11/04

(57) ABSTRACT

A galley monument for an aircraft has a number of compartment walls and a functional wall, which has a receiving recess extending in the direction of the depth, wherein the compartment walls and the functional wall together define at least one slide-in compartment of the galley monument. The galley monument also has a display arrangement with a display device, wherein the display arrangement can be stowed in the receiving recess in a stowage position, in which the display device is at least partially accommodated in the receiving recess. Also described is an aircraft which has at least one such galley monument.

### FIELD OF THE INVENTION

The present invention relates to a galley monument for an aircraft and to an aircraft.

### BACKGROUND OF THE INVENTION

Galleys on passenger aircraft typically comprise one or more galley monuments, i.e. individual prefabricated rack- or cupboard-like built-in assemblies, which often have a monolithic basic structure and make various functions available in an integrated way. Such galley monuments usually have slide-in compartments intended for receiving containers and/or trolleys or galley carts and/or for receiving various galley components for the preparation of meals and/or drinks. Galley components are for example hot water boilers, coffee machines, fan-assisted ovens, hotplates, sinks, coolboxes, refrigerators and the like.

In order to make as much space as possible available for passengers, it is attempted to integrate the galley monuments in the interior of the aircraft in a manner that saves as much space as possible. In passenger aircraft in particular, however, there is also increasingly the need for service functions and monitoring functions to be available in the cabin. For example, aircraft cabins are often fitted with surveillance cameras, the recorded images of which are shown on a display, so that the flight personnel can constantly keep an eye on the passengers.

Against the background of these requirements, DE 20 2017 004 091 U1 proposes a cabin monument in the form of a combined toilet/galley unit with an integrated display, wherein the monument has in addition to slide-in compartments for containers a stowage space for receiving the display when it is not in use.

### BRIEF SUMMARY OF THE INVENTION

Aspects of the present invention may provide a galley monument in which a display device is integrated in an improved way.

According to a first aspect of the invention, a galley monument for an aircraft is provided. The galley monument comprises a number of compartment walls and a functional wall, which has a receiving recess extending in the direction of the depth. The compartment walls and the functional wall together define at least one slide-in compartment of the galley monument. Furthermore, the galley monument has a display arrangement with a display device. The display arrangement can be stowed in the receiving recess. In a stowage position, the display device is at least partially accommodated in the receiving recess. That is to say that, in the stowage position, at least a part of the display device or the display device as a whole is arranged in the receiving recess, that is to say within the cross section of the functional wall.

An idea on which the invention is based is therefore that of stowing a display device within the cross section of a wall of the galley monument, which at the same time serves for delimiting a slide-in compartment. Such a wall is referred to here as a functional wall. For receiving the display device, the functional wall has a receiving recess as a stowage space, which extends from an end face of the functional wall in the direction of the depth of the galley monument.

This construction of the galley monument allows the display arrangement to be stowed in an extremely space-saving way. In particular, it is possible to dispense with an additional stowage space for the display device. Another advantage is that the display device can be slid into and removed from the receiving recess from the end face of the functional wall in the direction of the depth. As a result, stowage is possible independently of the occupancy of the slide-in compartment of the galley monument that is delimited by the functional wall. In particular, it avoids the need for a galley component that is in the slide-in compartment first having to be removed in order to remove or stow the display device. Furthermore, by being stowed in the cross section of the functional wall, the display arrangement is protected particularly safely from adverse mechanical effects, which may be caused for example by shaking or shocks from impact.

According to a further aspect of the invention, an aircraft, for example a passenger or freight aircraft, with such a galley monument is provided.

According to one embodiment of the galley monument, the display arrangement additionally has a carrier device, on which the display device is held, wherein the carrier device is guided in the receiving recess displaceably in the direction of the depth between the stowage position and an in-use position, in which the display device has been moved out of the receiving recess. According to this development, the display device is therefore mounted or fastened on a carrier device and the carrier device, which may for example be realized in the form of a frame or a rack, is guided displaceably in the receiving recess. For guiding the carrier device, guide rails that extend for example in the direction of the depth may be provided. In the in-use position, the display device has been moved out of the receiving recess, that is to say at least the display device and optionally also a part of the carrier device protrudes out of the receiving recess in the direction of the depth, and consequently beyond the end face of the functional wall. By way of the carrier device, the display arrangement is coupled to the functional wall and a guided, defined translatory movement is advantageously made possible. Furthermore, the carrier device forms a fastening of the display device on the functional wall. As a result, in the in-use position, the display device is available in a fixed position and need not be held by the flight personnel.

Optionally, the display device is pivotably mounted on the carrier device by means of an articulating device. The articulating device may for example be realized by a hinge or the like. The articulating device allows the display device to be pivoted about at least one pivot axis in the in-use position. As a result, in the in-use position, the display device can be pivoted into a desired position. This makes it easier for the flight personnel to acquire information from different viewing angles and viewing positions.

Local supply lines, such as power lines and/or data lines, for supplying to the display device may in this case run within the articulating device between the carrier device and the display device. For example, display cables may be led through the articulating device, in a way similar to how a display cable runs through the hinge of a laptop.

According to a further embodiment, in the stowage position, a peripheral portion of the display device protrudes beyond the end face of the functional wall with respect to the direction of the depth. That is to say that, in the stowage position, the display device protrudes partly out of the receiving recess. This offers the advantage that the peripheral portion of the display device that protrudes, and is consequently visible, can be used for displaying information for the flight personnel.

According to a further embodiment of the galley module, the display device has display elements on a first end face. If a carrier device is provided, the first end face is an end face of the display device that is opposite from the carrier device or remote from it. In the stowage position, this end face extends transversely to the direction of the depth. The display elements, for example in the form of light-emitting diodes (LEDs) or the like, are consequently advantageously visible on the end face of the functional wall in the stowage position, and can thus be used for conveying information even in the stowage position.

As an alternative to this, the first end face of the display device may also be of a curved shape and be formed as a display surface. In this case, a surface of the display device designed for displaying and/or reproducing image information forms the first end face. This may be realized for example by a display of the display device forming or having the curved end face. In this way it is likewise possible in the stowage position for information to be conveyed to the flight personnel on the end face of the functional wall.

According to a further embodiment of the galley monument, it is provided that a basic supply line for supplying to the display device runs between the display device and the functional wall with a length reserve within the receiving recess. The basic supply line may contain here power lines and/or data lines, which are directly connected to the display device or possibly to the carrier device. The length reserve provided in the receiving recess has the effect that space-saving cabling is achieved, and as a result the space requirement for the display arrangement is further reduced.

The basic supply line may be formed in particular as a ribbon cable and the length reserve may be formed by a loop of the ribbon cable. Ribbon cables offer the advantage that they can be made up freely in their length. Furthermore, ribbon cables can be deformed in a defined way, so that the probability of the length reserve causing the display arrangement to become jammed in the receiving recess is reduced.

According to a further embodiment of the galley monument, the display device has a recessed grip on a rear side surface. The recessed grip may for example be situated on a first peripheral portion of the display device. The recessed grip makes it easier to grip the display device, and consequently easier for it to be operated. In particular when, in the stowage position, the display device protrudes with the first peripheral portion beyond the end face of the functional wall, as described above, the recessed grip makes it easier for the display arrangement to be displaced between the stowage position and the in-use position.

According to one embodiment, the galley monument has a housing device arranged in the receiving recess. Therefore, a casing of the receiving recess that at least partially encloses the display arrangement in the stowage position is provided. Consequently, on the one hand the housing device forms a mechanical reinforcement of the functional wall. What is more, the housing device additionally protects the display arrangement from external influences such as shocks or heat. The optional carrier device may in particular be guided in the housing device.

The housing device may in particular have a tray for receiving the display arrangement in the stowage position. Optionally, a cover may be additionally provided, closing the tray in such a way that it is only left open towards the end face of the functional wall. A tray offers the advantage that it has a closed bottom, and consequently offers particularly reliable protection from heat and mechanical influences.

According to a further embodiment, the galley monument has an actuator, by means of which the display arrangement can be moved between the stowage position and the in-use position. The actuator is kinematically coupled to the display arrangement, for example by way of the carrier device. In particular, the actuator may be an electric motor that is integrated in the cross section of the functional wall. The actuator has the effect of increasing the operating convenience of the galley monument. Furthermore, the degree of automation is increased, which relieves the flight personnel and consequently also increases safety.

A display device is understood here as meaning in particular an electronic optical display, such as for example an LED, OLED, TFT or LCD screen or the like, with or without backlighting. In this case, the display device may also have touchscreens or the like, which in addition to information output also allow input by way of a screen serving as a touch panel.

With regard to directional indications and axes, in particular directional indications and axes relating to the profile of physical structures, a path of an axis, of a direction or of a structure “along” another axis, direction or structure is understood here as meaning that these, in particular the tangents that arise at a respective point of the structures, run in each case at an angle of less than or equal to 45 degrees, preferably less than or equal to 30 degrees, and particularly preferably parallel, to one another.

With regard to directional indications and axes, in particular directional indications and axes relating to the profile of physical structures, a path of an axis, of a direction or of a structure “transversely” with respect to another axis, direction or structure is understood here as meaning that these, in particular the tangents that arise at a respective point of the structures, run in each case at an angle of greater than 45 degrees, preferably greater than 60 degrees, and particularly preferably perpendicular, to one another.

### BRIEF DESCRIPTION OF THE DRAWINGS

Aspects of the invention are explained below with reference to the figures of the drawings. In the figures:

FIG. 1 shows a simplified, schematic view of an aircraft according to an exemplary embodiment of the present invention;

FIG. 2 shows a plan view of a front side of a galley that has a galley monument according to an exemplary embodiment of the present invention;

FIG. 3 shows a perspective partial view of a galley monument according to an exemplary embodiment of the present invention, wherein a display arrangement of the galley monument is arranged in a stowage position;

FIG. 4 shows a view of a detail of a display arrangement of a galley monument according to an exemplary embodiment of the present invention, wherein the display arrangement is arranged in the stowage position;

FIG. 5 shows a perspective partial view of the galley monument from FIG. 3, wherein the display arrangement of the galley monument is arranged in an in-use position;

FIG. 6 shows a view of a detail of a galley monument according to a further exemplary embodiment of the invention as a plan view of an end face of a functional wall of the galley monument;

FIG. 7 shows a view of a detail of a galley monument according to a further exemplary embodiment of the invention as a plan view of an end face of a functional wall of the galley monument; and

FIG. 8 shows a broken-away sectional view of a display device of a display arrangement of the galley monument represented in FIG. 7.

Unless otherwise stated, the same reference designations are used in the figures to denote identical or functionally identical components.

### DETAILED DESCRIPTION

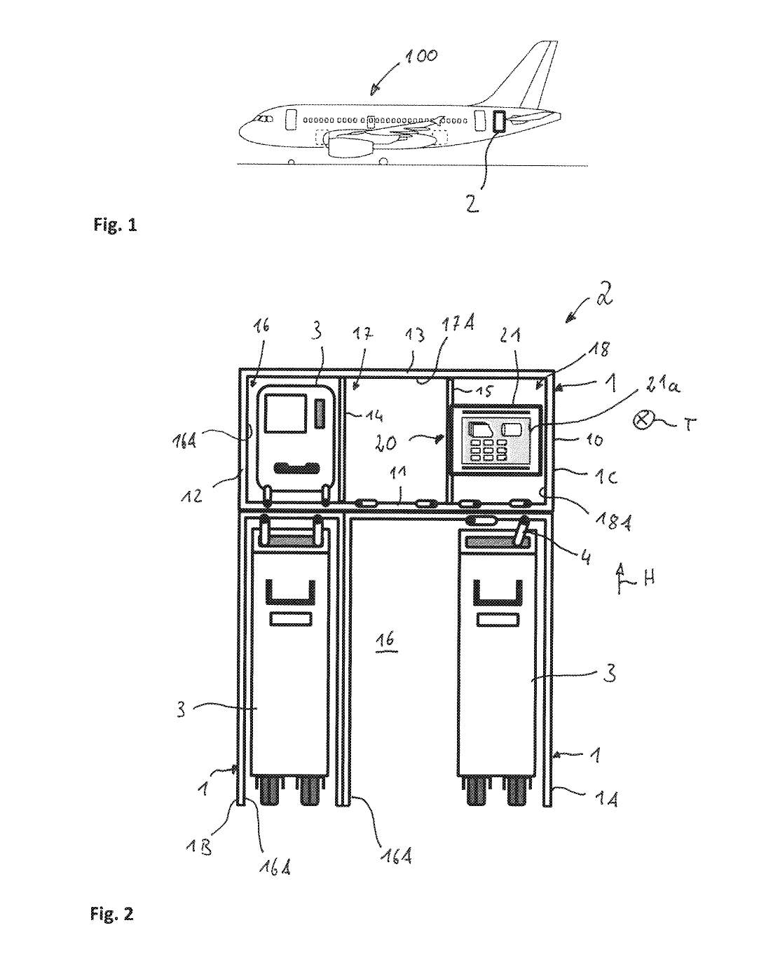

FIG. 2 shows a schematic front-side view of a galley 2. This may for example be provided in a passenger cabin of an aircraft 100, in particular a passenger aircraft, as is represented by way of example in FIG. 1. As can be seen in FIG. 1, the galley 2 can for example be arranged in the region of the tail of the aircraft 100 close to an entrance area.

The galley 2 that is represented in FIG. 2 purely by way of example has three galley monuments 1, 1A, 1B, 1C. Each of these galley monuments 1 has one or more slide-in compartments 16, 17, 18, which are designed for receiving one or more galley components 3.

Thus, a first galley monument 1A (bottom right in FIG. 2) has a slide-in compartment 16 for receiving two galley components 3, in this case two trolleys. A second galley monument 1B (bottom left in FIG. 2), arranged alongside the first galley monument 1A, has one slide-in compartment 16 for just a single trolley. Arranged over these two galley monuments 1A, 1B is a third galley monument 1C, which has three slide-in compartments 16, 17, 18, each for receiving a container, as galley components 3. The slide-in compartments 16, 17, 18 may for example have standardized dimensions for receiving standardized containers or the like.

Purely by way of example, two catches 4 are mounted on each of the slide-in compartments 16, 17, 18 on the respective galley monument 1. Each of these catches 4 is designed to be movable between a closed position and an open position. In the closed position, a galley component 3 located in the slide-in compartment 16, 17, 18 is locked fast or held fast in the slide-in compartment 16, 17, 18 by the catch 4. In the open position, the catch releases the respective slide-in compartment 16, 17, 18 for sliding in and for removing a galley component 3. For example, at the bottom left in FIG. 2 a trolley is held in the galley monument 1 by two catches 4.

The slide-in compartments 16, 17, 18 are in each case defined by compartment walls 10, 11, 12, 13, 14 and a functional wall 15 of the respective galley monument 1. The compartment walls 10, 11, 12, 13, 14 and also the functional wall 15 extend in a direction of the depth T of the galley monument 1.

In FIG. 2, the first and second galley monuments 1A and 1B have in each case as compartment walls two spaced-apart side walls 10, 12 and also a top wall 13 extending between the side walls 10, 12. The third galley monument 1C comprises as compartment walls two spaced-apart side walls 10, 12, a top wall 13 extending between the side walls 10, 12, a bottom wall 11 extending between the side walls 10, 12, which is opposite from the top wall 13 with respect to a direction of the height H of the galley monument 1, and also an intermediate wall 14, which is arranged at a distance from the side walls 10, 12 and extends between the bottom wall 11 and the top wall 13. A further intermediate wall 15, which extends between the bottom wall 11 and the top wall 13 and is arranged between the intermediate wall 14 and the side wall 10, forms the functional wall. The compartment walls 10, 11, 12, 13, 14 and the functional wall 15 of a respective galley monument 1A, 1B, 1C define at least one slide-in opening 16A, 17A, 18A of a respective slide-in compartment 16, 17, 18. For example, the side wall 12, the intermediate wall 14 and also the bottom wall 11 and the top wall 13 of the third galley monument 1C define a slide-in opening 16A.

In the case of the galley 2 shown by way of example in FIG. 2, the third galley monument 1C has the display arrangement 20. This comprises a display device 21. The display device 21 has a first surface 21a, which is formed by a surface of a display that is designed for displaying information. In FIG. 2, this is schematically represented by display symbols. The display arrangement 20 may be stowed in the cross section of the functional wall in a receiving recess 19 (not represented in FIG. 2). In FIG. 2, the display arrangement 20 is represented in an in-use position.

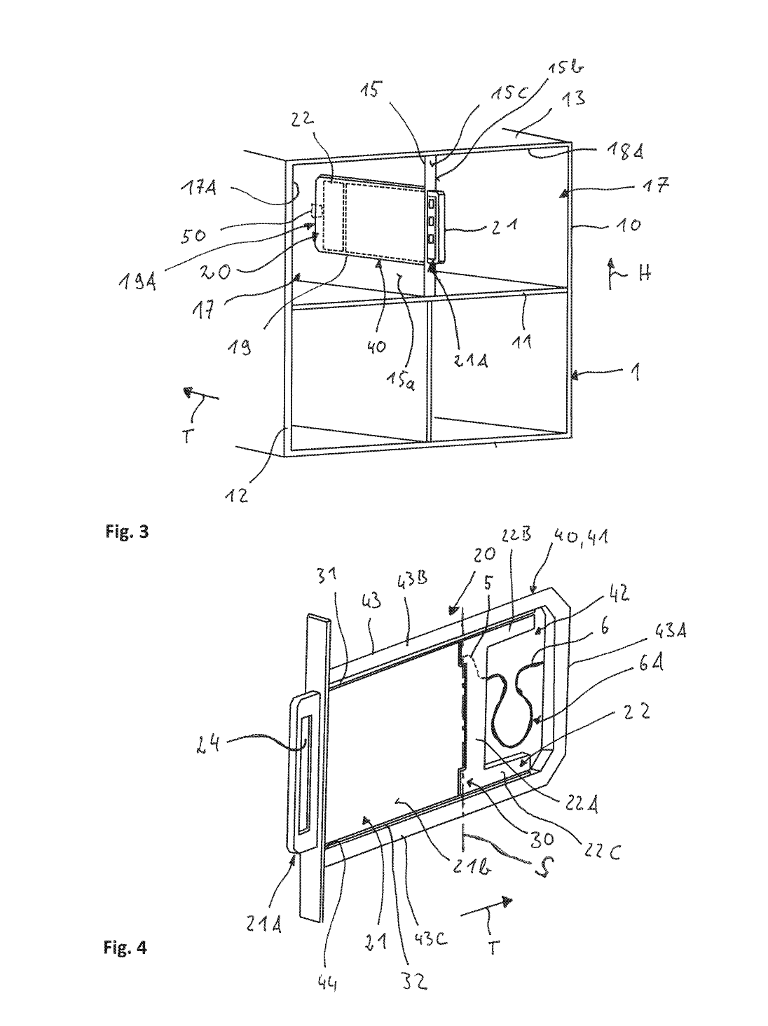

FIG. 3 shows a galley monument 1 in the case of which the display arrangement 20 is arranged in the stowage position. The functional wall 15 is in this case likewise represented by way of example as an intermediate wall, which is situated between two compartment walls 10, 11 formed as side walls and extends between a top wall and a compartment wall 11 formed as a bottom intermediate wall. As represented in FIG. 3, the compartment walls 10, 11, 12, 13 and the functional wall 15 extend in the direction of the depth T of the galley monument 1 and together define two slide-in compartments 17, 18 of the galley monument 1.

As shown in FIG. 3, the functional wall 15 has a receiving recess 19 for receiving the display arrangement 20 in the stowage position, which extends from an end face 15c of the functional wall 15 in the direction of the depth T. The end face 15c extends transversely to the direction of the depth T. The receiving recess 19 may for example be formed as a closed channel, which extends from the end face 15c in the direction of the depth T. Alternatively, the receiving recess 19 may form an opening on a first side face 15a and/or a second side face 15b, opposite from the first side face, of the functional wall 15, as is shown by way of example in FIG. 3.

In FIG. 3, an optional housing device 40 is arranged in the receiving recess 19 and is further explained in detail below with reference to FIG. 4.

As schematically represented in FIG. 3, the display arrangement 20 has the display device 21 and an optional carrier device 22, on which the display device 21 is held. The carrier device 22 is merely schematically represented in FIG. 3 and is further explained in detail below with reference to FIG. 4.

FIG. 3 schematically shows the display arrangement 20 in the stowage position. In this stowage position, the display arrangement 20 is at least partially accommodated in the receiving recess 19. As can be seen in FIG. 3, here the optional carrier device 22 is positioned completely in the receiving recess 19. In the stowage position, a first end portion 21A of the display device 21 may protrude beyond the end face with respect to the direction of the depth T, as is shown by way of example in FIG. 3. As a result, a peripheral region of a display forming the first surface 21a of the display device 21 protrudes beyond the end face 15c and symbols displayed there can be read by the flight personnel. It goes without saying that, in the stowage position, the first peripheral portion 21A of the display device 21 can also be arranged within the receiving recess 19. Generally, in the stowage position, the display arrangement 20 is arranged at least partially within the cross section of the functional wall 15 with respect to the direction of the depth T.

Optionally, the display arrangement 20 may be locked in the stowage position, that is to say secured against displacement in the direction of the depth T. This may be achieved with an arresting device (not represented), for example in the form of a catch similar to those of FIG. 2 or in the form of a securing clasp, which extends beyond the end wall 15a between the first and second side faces 15a, 15b.

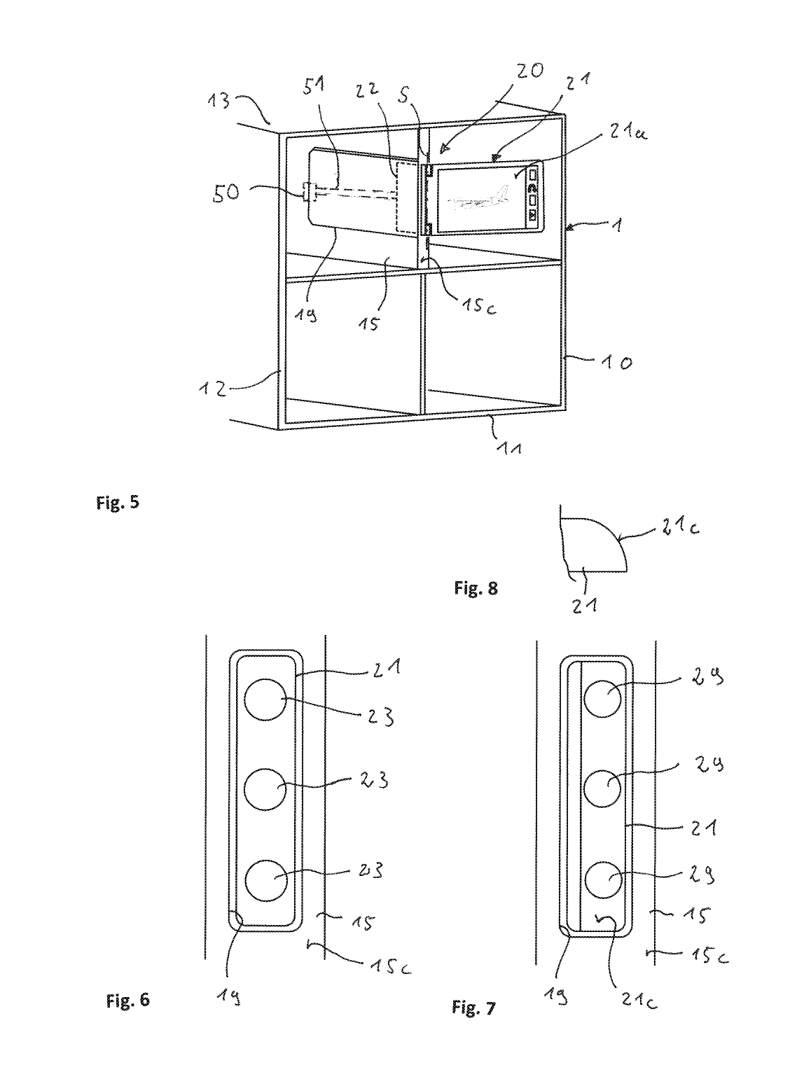

As can also be seen in FIG. 3, an actuator 50 may be provided, by means of which the display arrangement 20 can be moved between the stowage position and the in-use position. In FIG. 3, the actuator 50 is merely represented symbolically and, as can be seen in FIG. 3, can in particular be arranged on an end portion 19A of the receiving recess 19 that is opposite from the end face 15c of the functional wall 15 with respect to the direction of the depth T. The optional actuator 50 may for example be formed as an electric motor, which drives a spindle drive 51 (FIG. 5), which is coupled to the display arrangement 20 and is designed to displace the display arrangement 20 along the direction of the depth T.

FIG. 4 shows a display arrangement 20 and a housing device 40, as they are installed for example in the galley monument 1 shown in FIG. 3.

As shown by way of example in FIG. 4, the optional housing device 40 may have a tray 41 for receiving the display arrangement 20 in the stowage position. The tray 41 has an approximately rectangular, plate-like bottom 42, which extends in the direction of the depth T, that is to say along the side faces 15a, 15b of the functional wall 15. The tray 41 also has a frame 43, which projects from the bottom 42. The frame 43 has a transverse profile 43A, which is arranged at a first end of the bottom 42 and extends transversely to the direction of the depth T, and two side profiles 43B, 43C, which extend from the transverse profile 43A in the direction of the depth T and form a guide opening 44 for leading the display device 21 through in a second end of the bottom that is opposite from the first end with respect to the direction of the depth T. Optionally, a shutter 45, which has an opening corresponding to the guide opening 44, may also be provided. The configuration of the housing device 40 as a tray 41 that is shown in FIG. 4 is purely by way of example. For example, it is also conceivable to realize a housing device 40 as a frame which is constructed like the frame 43 of the tray 41.

Also shown in FIG. 4 is a carrier device 22, on which the display device 21 is held. The carrier device 22 shown by way of example generally comprises a guiding portion, which is designed for the displaceable mounting in the receiving recess, in particular in the optional housing device 40, and a holding portion, which is designed for the mechanical coupling to the display device 21.

The holding portion may be formed in particular by a web-shaped carrier profile 22A, as is shown by way of example in FIG. 4, and have a coupling structure for coupling to the display device 21. For example, the display device 21 may be pivotably mounted on the carrier device 22 by means of an articulating device 30. The coupling structure of the holding portion may be formed here for example by a hinge or by a first articulating part, for example in the form of a pin, while the display device has a corresponding, complementary second articulating part, for example in the form of a bush. The articulating device 30 defines a pivot axis S, as is schematically depicted in FIG. 4.

As also schematically represented in FIG. 4, supply lines 5 for supplying to the display device 21 may run between the carrier device 22 and the display device 21 within the articulating device 30.

The guiding portion of the carrier device 22 may be formed in particular by guiding profiles 22B, 22C, which extend in the direction of the depth T and extend from the holding structure, that is to say out of the carrier profile 22A. In particular, the carrier profile 22A and the guiding profiles 22B, 22C may be formed in one piece.

For guiding the carrier structure along the direction of the depth T, guiding structures extending in the direction of the depth T may be provided in the receiving recess 19, for example in the form of guide rails 31, 32. These may be arranged directly on the functional wall 15 or, as shown by way of example in FIG. 4, on the housing device 40. In FIG. 4, the guide rails 31, 32 are arranged on the side webs 43B, 43C of the frame 43. In this way, the carrier device 22 is guided in the receiving recess 19 displaceably in the direction of the depth T between the stowage position and the in-use position.

As also schematically shown in FIG. 4, a basic supply line 6 for supplying to the display device 21, that is to say a line that contains power and/or data lines, may run within the receiving recess 19. In FIG. 4 it is shown by way of example that the basic supply line 6 runs within the housing device 40 arranged in the receiving recess 19. For this purpose, the housing device 40 may have a corresponding line recess (not represented) for leading the basic supply line 6 through, for example in the transverse profile 43A of the frame 43. As shown in FIG. 4, the basic supply line 6 has a length reserve 6A. This may be formed for example by a loop of a cable, which forms the basic supply line 6. Alternatively, the length reserve 6A may also be formed by the basic supply line 6 being formed by a spiral cable. As shown in FIG. 4, the basic supply line 6 may run between the functional wall 15 (not represented in FIG. 4) and the carrier device 22, in particular the holding portion of the carrier device 22. Alternatively, the basic supply line 6 may run between the functional wall 15 and the display device 21. Generally, the basic supply line 6 runs between the display arrangement 20 and the functional wall 15. The basic supply line 6 may be formed in particular as a ribbon cable, as is schematically represented in FIG. 4.

As also represented by way of example in FIG. 4, the display device 21 may have a recessed grip 24 on a rear side surface 21b, which is opposite from the first surface 21a. This recessed grip may be arranged in particular in the region of the first end portion 21A of the display device 21, as shown in FIG. 4.

FIG. 5 shows the display arrangement 20 in the in-use position. In the in-use position, the display device 21 has been moved out of the receiving recess 19. As shown in FIG. 5, at least the display device 21 and optionally also a part of the carrier device 22, for example the holding portion of the carrier device 22, protrude(s) here out of the receiving recess 19 and beyond the end face 15c of the functional wall 15 in the direction of the depth T. If an articulating device 30 is provided, the display device 21 can be pivoted about the pivot axis S in relation to the carrier device 22, and consequently in relation to the functional wall 15, as is represented by way of example in FIG. 5.

In the in-use position, the first surface 21a of the display device 21 has been moved completely out of the functional wall 15 and can be used for displaying information and also as an operator interface for operating galley components. Also, images recorded for example by a camera device can be shown on the display forming the first surface 21a.

The display arrangement may be moved into the in-use position in particular by means of the optional actuator 50 or manually by an operator pulling it out of the receiving recess 19 counter to the direction of the depth T.

As shown in FIG. 6, the display device 21 may have display elements 23 on a first end face 21c. As can be seen in FIG. 6, in the stowed state of the display arrangement 20, the first end face 21c is situated with respect to the direction of the depth T at the end face 15c of the functional wall 15. The display elements 23 may for example be realized as LEDs and serve the purpose of making certain information more easily available to the flight personnel when the display arrangement 20 is arranged in the stowage position. For example, it may be provided that one of the display elements 23 flashes or changes colour if a certain event occurs, for example if a passenger unfastens his or her seatbelt during takeoff or landing, a galley unit is defective or the like.

Another possibility for making certain information more easily available to the flight personnel when the display arrangement 20 is arranged in the stowage position is schematically represented in FIGS. 7 and 8. Here, the first end face 21c of the display device 21 is of a curved shape and is formed as a display surface. For example, the display that forms the first surface 21a may also be designed for displaying information, for example in the form of symbols 29, in the region of the end face 21c.

Although the present invention has been explained above by way of example on the basis of exemplary embodiments, it is not restricted to these, but instead can be modified in various ways. In particular, combinations of the foregoing exemplary embodiments are also conceivable.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF DESIGNATIONS

1 Galley monument
1A First galley monument
1B Second galley monument
1C Third galley monument
2 Galley
3 Galley components
4 Catches
5 Local supply lines
6 Basic supply line
10-14 Compartment walls
15a First inner surface
15b Second inner surface
15c End face
16-18 Slide-in compartment
16A, 17A, 18A Slide-in opening
19 Receiving recess
20 Display arrangement
20a First surface of the display device
21 Display device
21A Peripheral portion of the display device
21a First surface of the display device
21c End face of the display device
22 Carrier device
22A Carrier profile of the carrier device
22B, 22C Guiding profiles of the carrier device
23 Display elements
24 Recessed grip
29 Symbols
30 Articulating device
31, 32 Guide rails
40 Housing device
41 Tray
42 Bottom
43 Frame
43A Transverse profile
43B, 43C Side profile
44 Guide opening
50 Actuator
51 Spindle drive
100 Aircraft
H Direction of the height
T Direction of the depth

1. A galley monument for an aircraft, comprising:
a number of compartment walls and a functional wall having a receiving recess extending in the direction of the depth, wherein the compartment walls and the functional wall together define at least one slide-in compartment of the galley monument; and
a display arrangement with a display device, wherein the display arrangement is configured to be stowed in the receiving recess in a stowage position, wherein the display device is at least partially accommodated in the receiving recess in the stowage position.

2. The galley monument according to claim 1, wherein the display arrangement comprises a carrier device, on which the display device is held, and wherein the carrier device is guided in the receiving recess displaceably in the direction of the depth between the stowage position and an in-use position, in which the display device has been moved out of the receiving recess.

3. The galley monument according to claim 2, wherein the display device is pivotably mounted on the carrier device by an articulating device.

4. The galley monument according to claim 3, wherein local supply lines for supplying to the display device run between the carrier device and the display device within the articulating device.

5. The galley monument according to claim 1, wherein, in the stowage position, a peripheral portion of the display device protrudes beyond an end face of the functional wall with respect to the direction of the depth.

6. The galley monument according to claim 1, wherein the display device has display elements on a first end face.

7. The galley monument according to claim 1, wherein a first end face of the display device is of a curved shape and is formed as a display surface.

8. The galley monument according to claim 1, wherein a basic supply line for supplying to the display device runs between the display device and the functional wall with a length reserve within the receiving recess.

9. The galley monument according to claim 8, wherein the basic supply line is formed as a ribbon cable and the length reserve is formed by a loop of the ribbon cable.

10. The galley monument according to claim 1, wherein the display device has a recessed grip on a rear side surface.

11. The galley monument according to claim 1, further comprising:
a housing device arranged in the receiving recess.

12. The galley monument according to claim 11, wherein the housing device comprises a tray for receiving the display arrangement in the stowage position.

13. The galley monument according to claim 2, further comprising:
an actuator, by which the display arrangement can be moved between the stowage position and the in-use position.

14. An aircraft with a galley monument according to claim 1.
